(19) United States
(12) Patent Application Publication
(10) Pub. No.: US 2001/0003174 A1
(43) Pub. Date: Jun. 7, 2001

(54) Method of generating a maximum entropy speech model

(76) Inventor: Jochen Peters, Aachen (DE)

Correspondence Address: Corporate Patent Counsel, U.S. Philips Corporation, 580 White Plains Road, Tarrytown, NY, 10591, US

(21) Appl. No.: 09/725,419

(22) Filed: Nov. 29, 2000

(30) Foreign Application Priority Data
Nov. 30, 1999 (DE) 19957430.8

(51) Int. Cl. G10L 15/00; G10L 15/08; G10L 15/12

(52) U.S. Cl. 704/240

(57) ABSTRACT

The invention relates to a method of generating a maximum entropy speech model for a speech recognition system.

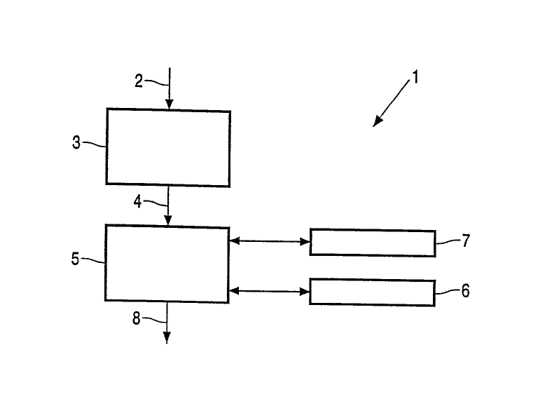

To improve the statistical properties of the generated speech model there is proposed that:

by evaluating a training corpus, first probability values p_{ind}(w|h) are formed for N-grams with N≧0;

an estimate of second probability values pλ(w|h), which represent speech model values of the maximum entropy speech model, is made in dependence on the first probability values;

boundary values m_{α}are determined according to the equation

$${m}_{α} = {\sum }_{( h , w )} {p}_{ind} ( w \vert h ) \cdot N ( h ) \cdot {f}_{α} ( h , w )$$

where N(h) is the rate of occurrence of the respective history h in the training corpus and f_{α}(h, w) is a filter function which has a value different from zero only for certain N-grams predefined a priori and featured by the index α, and otherwise has the zero value;

an iteration of speech model values of the maximum entropy speech model is continued until values m_{α}⁽ⁿ⁾ determined in the n^{th} iteration step according to the formula

$${m}_{α}^{( n )} = {\sum }_{( h , w )} {p}_{λ}^{( n )} ( w \vert h ) \cdot N ( h ) \cdot {f}_{α} ( h , w )$$

sufficiently accurately approach the boundary values m_{α}according to a predefinable convergence criterion.

The invention relates to a method of generating a maximum entropy speech model for a speech recognition system.

When speech models are generated for speech recognition systems, there is the problem that the training corpora contain only limited quantities of training material. Probabilities of speech utterances that are only derived from the respective rates of occurrence in the training corpus are therefore subjected to smoothing procedures, for example, by backing-off techniques. However, backing-off speech models generally do not optimally utilize available training data, because unseen histories of N-grams are only compensated in that the respectively considered N-gram is shortened until a non-zero rate of occurrence in the training corpus is obtained. With maximum entropy speech models this problem may be counteracted (compare R. Rosenfeld, “A maximum entropy approach to adaptive statistical language modeling”, Computer, Speech and Language, 1996, pp. 187-228). By means of such speech models both rates of occurrence of N-grams and gap N-grams in the training corpus can be used for the estimation of speech model probabilities, which is not the case with backing-off speech models. However, during the generation of a maximum entropy speech model the problem occurs that suitable boundary values are to be estimated on whose selection the iterated speech model values of the maximum entropy speech model depend. The speech model probabilities p_{λ}(w|h) of such a speech model (w: vocabulary element; h: history of vocabulary elements relative to w) can be determined during a training, so that they satisfy as well as possible the boundary value equations of the form

$${m}_{α} = {\sum }_{( h , w )} {p}_{λ} ( w \vert h ) \cdot N ( h ) \cdot {f}_{α} ( h , w )$$

m_{α}then represents a boundary value for a condition α to be set a priori, on whose satisfaction it depends whether the filter function f_{α}(h, w) adopts the one value or the zero value. A condition α is then whether a considered sequence (h, w) of vocabulary elements is a certain N-gram (the term N-gram also includes gap N-grams), or ends in a certain N-gram (N≧1), while N-gram elements may also be classes that contain vocabulary elements that have a special relation to each other. N(h) denotes the rate of occurrence of the history h in the training corpus.

From all the probability distributions that satisfy the boundary value equations the distribution that maximizes the specific entropy

$$- {\sum }_{h} N ( h ) {\sum }_{w} {p}_{λ} ( w \vert h ) log {p}_{λ} ( w \vert h )$$

is selected for the maximum entropy modeling. The special distribution has the form of

$${p}_{λ} ( w \vert h ) = \frac{1}{{Z}_{λ} ( h )} exp \{ {\sum }_{α} {λ}_{α} {f}_{α} ( h , w ) \} with {Z}_{λ} ( h ) = {\sum }_{v ∈ V} exp \{ {\sum }_{α} {λ}_{α} {f}_{α} ( h , v ) \}$$

with suitable parameters λ_{α}.

For the iteration of a maximum entropy speech model, specifically the so-called GIS algorithm (Generalized Iterative Scaling) is used, whose basic structure is described in J. N. Darroch, D. Ratcliff: “Generalized iterative scaling for log-linear models”, The Annals of Mathematical Statistics, 43(5), pp. 1470-1480, 1972. An attempt at determining the said boundary values m_{α}is based, for example, on the maximization of the probability of the training corpus used, which leads to boundary values m_{α}=N(α), i.e. there is determined how often the conditions α are satisfied in the training corpus. This is described, for example, in S. A. Della Pietra, V. J. Della Pietra, J. Lafferty, “Inducing Features of random fields”, Technical report, CMU-CS-95-144, 1995. The boundary values m_{α}, however, often force several speech model probability values p_{λ}(w|h) of the models restricted by the boundary value equations to disappear (i.e. become zero), more particularly for sequences (h, w) not seen in the training corpus. Disappearing speech model probability values p_{λ}(w|h) are to be avoided for two reasons, however: the first reason is that a speech recognition system could in such cases not recognize lines with the word sequence (h, w), even if they were plausible recognition results, only because they do not appear in the training corpus. The other reason is that values p_{λ}(w|h)=0 contradict the functional form of the solution from the above equation for p_{λ}(w|h) as long as the parameters λ_{α}are limited to finite values. This so-called inconsistency (compare J. N. Darroch, D. Ratcliff mentioned above) prevents the solution of the boundary value equations with all the training methods known so far.

It is now the object of the invention to provide a method of generating maximum entropy speech models, so that an improvement of the statistical properties of the generated speech model is achieved.

The object is achieved in that:

by evaluating a training corpus, first probability values P_{ind}(w|h) are formed for N-grams with N≧0;

an estimate of second probability values p_{λ}(w|h), which represent speech model values of the maximum entropy speech model, is made in dependence on the first probability values;

boundary values m_{α}are determined which correspond to the equation

$${m}_{α} = {\sum }_{( h , w )} {p}_{ind} ( w \vert h ) \cdot N ( h ) \cdot {f}_{α} ( h , w )$$

where N(h) is the rate of occurrence of the respective history h in the training corpus and f_{α}(h, w) is a filter function which has a value different from zero for specific N-grams predefined a priori and featured by the index α, and otherwise has the zero value;

an iteration of speech model values of the maximum entropy speech model is continued to be made until values m_{α}⁽ⁿ⁾ determined in the n^{th} iteration step according to the formula

$${m}_{α}^{( n )} = {\sum }_{( h , w )} {p}_{λ}^{( n )} ( w \vert h ) \cdot N ( h ) \cdot {f}_{α} ( h , w )$$

sufficiently accurately approach the boundary values m_{α}in accordance with a predefinable convergence criterion.

Forming a speech model in this manner leads to a speech model that generalizes the statistics of the training corpus better to the statistics of the speech to be recognized, in that the estimate of the probabilities p_{λ}(w|h) uses different statistics of the training corpus for unseen word transitions (h, w): Besides the N-grams having a shorter range (as with backing-off speech models), it is also possible to take into account gap N-gram statistics and correlations between word classes when the values p_{λ}(w|h) are estimated.

There is more particularly provided that for the iteration of the speech model values of the maximum entropy speech model i.e. for the iterative training, the GIS algorithm is used. The first probability values P_{ind}(w|h) are preferably backing-off speech model probability values.

The invention also relates to a speech recognition system with an accordingly structured speech model.

Examples of embodiment of the invention will be further explained in the following with reference to a drawing FIGURE.

The FIGURE shows a speech recognition system 1 whose input 2 is supplied with speech signals in electrical form. A function block 3 summarizes an acoustic analysis, which leads to the fact that attribute vectors describing the speech signals are successively produced on the output 4. During the acoustic analysis the speech signals occurring in electrical form are sampled and quantized and subsequently combined to frames. Successive frames then preferably partly overlap. For each respective frame an attribute vector is formed. The function block 5 summarizes the search for the sequence of speech vocabulary elements that is the most probable for the entered sequence of attribute vectors. As is customary in speech recognition systems, the probability of the recognition result is then maximized with the aid of the so-called Bayes formula. Both an acoustic model of the speech signals (function block 6) and a linguistic speech model (function block 7) play a role in the processing according to function block 5. The acoustic model according to function block 6 implies the customary use of so-called HMM models (Hidden Markov Models) for the modeling of individual vocabulary elements or also a combination of a plurality of vocabulary elements. The speech model (function block 7) contains estimated probability values for vocabulary elements or sequences of vocabulary elements. This is referred to by the invention further to be explained hereinafter, which leads to the fact that the error rate of the recognition result produced on the output 8 is reduced. Furthermore, the complexity of the system is reduced.

In the speech recognition system 1 according to the invention a speech model having probability values p_{λ}(w|h) i.e. certain N-gram probabilities with N≧0 is used for N-grams (h, w) (with h as the history of N−1 elements with respect to the vocabulary element w), which is based on a maximum entropy estimate. The searched distribution is then limited by certain marginal distributions and under these marginal conditions the maximum entropy model is chosen. The marginal conditions may relate both to N-grams of different lengths (N= 1, 2, 3, . . .) and to gap N-grams, for example, to gap bigrams of the form (u, *, w), where * is a position retainer for at least one arbitrary N-gram element between the elements u and w. Similarly, N-gram elements may be class C elements, which summarize vocabulary elements that have a special relation to each other, for example, in that they show grammatical or semantic relations.

The probabilities p_{λ}(w|h) are estimated in a training on the basis of a training corpus (for example, NAB corpus—North American Business News) according to the following formula:

$${p}_{λ} ( w \vert h ) = \frac{1}{{Z}_{λ} ( h )} exp \{ {\sum }_{α} {λ}_{α} {f}_{α} ( h , w ) \} with {Z}_{λ} ( h ) = {\sum }_{v ∈ V} exp \{ {\sum }_{α} {λ}_{α} {f}_{α} ( h , v ) \} \qquad ( 1 )$$

The quality factor of the speech model thus formed is decisively determined by the selection of boundary values m_{α}on which the probability values p_{λ}(w|h) for the speech model depend, which is expressed by the following formula:

$${m}_{α} = {\sum }_{( h , w )} {p}_{λ} ( w \vert h ) \cdot N ( h ) \cdot {f}_{α} ( h , w ) \qquad ( 2 )$$

The boundary values m_{α}are estimated by means of an already calculated and available speech model having the speech model probabilities p_{ind}(w|h). Formula (2) is used for this purpose, in which only p_{λ}(w|h) is to be replaced by p_{ind}(w|h), so that an estimate is made of the m_{α}in accordance with formula

$${m}_{α} = {\sum }_{( h , w )} {p}_{ind} ( w \vert h ) \cdot N ( h ) \cdot {f}_{α} ( h , w ) \qquad ( 3 )$$

The values p_{ind}(w|h) are specifically probability values of a so-called backing-off speech model determined on the basis of the training corpus (see, for example, R. Kneser, H. Ney, “Improved backing-off for M-gram language modeling”, ICASSP 1995, pp. 181-185). The values p_{ind}(w|h) may, however, also be taken from other (already calculated) speech models assumed to be defined, as they are described, for example, in A. Nadas: “Estimation of Probabilities in the Language Model of the IBM Speech Recognition System”, IEEE Trans. on Acoustics, Speech and Signal Proc., Vol. ASSP-32, pp. 859-861, August 1984 and in S. M. Katz: “Estimation of Probabilities from Sparse Data for the Language Model Component of a Speech Recognizer”, IEEE Trans. on Acoustics, Speech and Signal Proc., Vol. ASSP-35, pp. 400-401, March 1987.

N(h) indicates the rate of the respective history h in the training corpus. f_{α}(h, w) is a filter function corresponding to a condition α, which filter function has a value different from zero (here the value one) if the condition α is satisfied, and is otherwise equal to zero. The conditions a and the associated filter functions f_{α}are heuristically determined for the respective training corpus. More particularly a choice is made here for which word or class N-grams or gap N-grams the boundary values are fixed.

Conditions α for which f_{α}(h, w) has the value one, are preferably:

a considered N-gram ends in a certain vocabulary element w;

a considered N-gram (h, w) ends in a vocabulary element w which belongs to a certain class C, which summarizes vocabulary elements that have a special relation to each other (see above);

a considered N-gram (h, w) ends at a certain bigram (v, w) or a gap bigram (u, *, w) or a specific trigram (u, v, w), etc.;

a considered N-gram (h, w) ends in a bigram (v, w) or a gap bigram (u, *, w), etc., where the vocabulary elements u, v and w lie in certain predefined word classes C, D and E.

In addition to the derivation of all the boundary values m_{α}according to equation (3) from a predefined a priori speech model with probability values p_{ind}(w|h), for certain groups of conditions ax can respectively be predefined their own a priori speech models with probability values p_{ind}(w|h), while the boundary values according to equation (3) are then in this case separately calculated for each group from the associated a priori speech model. Examples for possible groups may particularly be formed by:

word unigrams, word bigrams, word trigrams;

word gap-1-bigrams (with a gap corresponding to a single word);

word gap-2-bigrams (with a gap corresponding to two words);

class unigrams, class bigrams, class trigrams;

class gap-1-bigrams;

class gap-2-bigrams.

The speech model parameters λ_{α}are determined here with the aid of the GIS algorithm whose basic structure was described, for example, by J. N. Darroch, D. Ratcliff. A value M with

$$M = {max}_{( h , w )} \{ {\sum }_{α} {f}_{α} ( h , w ) \} \qquad ( 4 )$$

is then estimated. Furthermore, N then stands for the magnitude of the training corpus used i.e. the number of vocabulary elements the training corpus contains. Thus the GIS algorithm used may then be described as follows:

Step 1: Start with any start value

$${p}_{λ}^{( 0 )} ( w \vert h )$$

Step 2: Updating of the boundary values in the n^{th} travel through the iteration loop:

$${m}_{α}^{( n )} = {\sum }_{( h , w )} {p}_{λ}^{( n )} ( w \vert h ) \cdot N ( h ) \cdot {f}_{α} ( h , w ) \qquad ( 5 )$$

where

$${p}_{λ}^{( n )} ( w \vert h )$$

is calculated from the parameters

$${λ}_{a}^{( n )}$$

determined in step 3 by insertion into formula (1).

Step 3: Updating of the parameters λ_{α}:

$${λ}_{α}^{( n + 1 )} = {λ}_{α}^{( n )} + \frac{1}{M} \cdot log ( \frac{{m}_{α}}{{m}_{α}^{( n )}} ) - \frac{1}{M} \cdot log ( \frac{M \cdot N - {\sum }_{β} {m}_{β}}{M \cdot N - {\sum }_{β} {m}_{β}^{( n )}} ) \qquad ( 6 )$$

where the term subtracted last is dropped, where for M holds:

$$M = {\sum }_{β} {f}_{β} ( h , w ) ∀ ( h , w ) \qquad ( 7 )$$

m_{α}or m_{β}(^{β}is only another running variable) are the boundary values estimated according to formula (3) on the basis of the probability values p_{ind}(w|h).

Step 4: Continuation of the algorithm with step 2 up to convergence of the algorithm.

Convergence of the algorithm is understood to mean that the value of the difference between the estimated m_{α}of formula (3) and the iterated value m_{α}⁽ⁿ⁾ is smaller than a predefinable and sufficiently small limit value ^{ε}.

As an alternative for the use of the GIS algorithm, any method may be used that calculates the maximum entropy solution for predefined boundary conditions, for example, the Improved Iterative Scaling method which was described by S. A. Della Pietra, V. J. Della Pietra, J. Lafferty (compare above).

1. A method of generating a maximum entropy speech model for a speech recognition system in which:
by evaluating a training corpus, first probability values P_{ind}(w|h) are formed for N-grams with N≧0;
an estimate of second probability values p_{λ}(w|h), which represent speech model values of the maximum entropy speech model, is made in dependence on the first probability values;
boundary values m_{α}are determined which correspond to the equation
$${m}_{α} = {\sum }_{( h , w )} {p}_{ind} ( w \vert h ) \cdot N ( h ) \cdot {f}_{α} ( h , w )$$
where N(h) is the rate of occurrence of the respective history h in the training corpus and f_{α}(h, w) is a filter function which has a value different from zero for specific N-grams predefined a priori and featured by the index α, and otherwise has the zero value;
an iteration of speech model values of the maximum entropy speech model is continued to be made until values m_{α}⁽ⁿ⁾ determined in the n^{th} iteration step according to the formula
$${m}_{α}^{( n )} = {\sum }_{( h , w )} {p}_{λ}^{( n )} ( w \vert h ) \cdot N ( h ) \cdot {f}_{α} ( h , w )$$
sufficiently accurately approach the boundary values m_{α}according to a predefinable convergence criterion.

2. A method as claimed in claim 1, characterized in that for the iteration of the speech model values of the maximum entropy speech model, the GIS algorithm is used.

3. A method as claimed in claim 1 or 2, characterized in that a backing-off speech model is provided for producing the first probability values.

4. A method as claimed in claim 1, characterized in that for calculating the boundary values m_{α}for various sub-groups, which summarize groups of a specific α, various first probability values p_{ind}(w|h) are used.

5. A speech recognition system with a speech model generated as claimed in one of the claims 1 to 4.
